(19) United States
(12) Patent Application Publication
(10) Pub. No.: US 2012/0029977 A1
(43) Pub. Date: Feb. 2, 2012

(54) Self-Extending Monitoring Models that Learn Based on Arrival of New Data

(75) Inventors: John W. Alcorn, Youngsville, NC (US); Joachim H. Frank, Greenwich, CT (US)

(73) Assignee: INTERNATIONAL BUSINESS MACHINES CORPORATION, Armonk, NY (US)

(21) Appl. No.: 12/847,589

(22) Filed: Jul. 30, 2010

(51) Int. Cl. G06Q 10/00

(52) U.S. Cl. 705/7.39

(57) ABSTRACT

Mechanisms are provided for monitoring a process of a data processing system. With these mechanisms, a notification of an event comprising information regarding the event, and a process running in the data processing system that generated the event, is generated. It is determined whether one or more key performance indicators (KPIs) have been defined for an element corresponding to the process, in a model of the data processing system. In response to one or more KPIs not having been defined for an element in the model corresponding to the process, new KPI definitions are generated for the element in the model corresponding to the process based on specified default KPIs. The new KPI definitions constitute an extension of the model of the data processing system to thereby generate an extended model of the data processing system. The extended model is then used to monitor an operation of the data processing system.

### BACKGROUND

The present application relates generally to an improved data processing apparatus and method and more specifically to mechanisms for providing self-extending monitoring models that learn based on the arrival of new data.

Businesses utilize computers to improve the productivity of their employees and manage operations. Today businesses rely on a plurality of performance data derived from differing systems and applications that provide data in different formats. Moreover, each system/application provides information regarding different aspects of a business operation. As a result, business professionals must expend a large amount of time and energy to consolidate and digest great quantities of data to determine what is important to its business and its future goals. Key performance indicators (KPIs) can facilitate providing a business decision maker with a consolidated understanding of company performance. This allows decision makers, such as business owners, system administrators, and the like, to keep track of the operation of the business and act quickly to take advantage of opportunities to propel business forward toward established goals and objectives.

Key performance indicators (KPIs) are customizable business metrics utilized to present the status and trends in an organization in an easily cognizable manner. Once a business or other organization defines its mission or objectives, KPIs can be employed to measure progress toward those objectives. In general, each KPI can have a target value and an actual value. The target value represents a quantitative goal or object that is considered key or critical to the success of a business or organization. Thus, target values can be quite different for distinct businesses as their goals and focus is often dissimilar. For example, business can have KPIs concerning sales, net profit, and debt ratio, while a school may define a KPI related to graduation rate. Of course, the target value can change over time but is for the most part a stable value. The actual value is the value that fluctuates often based on the actions and performance of a business or organization. Actual values can be compared to target values to determine a business' health or progress toward the target value. Thus, KPIs are advantageous in that they provide a clear description of organizational goals and distill vast quantities of data down to a single value that can be utilized to continuously monitor business performance and its progress toward organization benchmarks.

Business decision makers have been utilizing KPI applications for some time now to measure the health of their business. KPI applications conventionally contain logic expressions for calculating the value of the KPI. These applications can then retrieve specific data specified by the expression and execute the logic to determine the KPI value. Subsequently, such calculated data can be displayed in a convenient mariner such as presenting the KPI value, the threshold and some graphical indication of performance based on the value and the threshold. For example, if the value is above the threshold then a graphical representation, such as a green light, thumbs up symbol, or the like, can be displayed. Alternatively, if the value is below the threshold then a graphical representation of a red light, thumbs down symbol, or the like, can be displayed.

Development of a KPI application includes several steps. First, a user or organization is queried to determine which KPIs they would like to be implemented in accordance with their mission and goals. Next, the functions or expressions that produce the KPIs are determined based on knowledge of the relevant database schema and specified in a specific API application. This enables the application to interact directly with a database based on its knowledge of the database schema to retrieve data necessary to calculate KPI values.

### SUMMARY

In one illustrative embodiment, a method, in a data processing system, is provided for monitoring a process of data processing system. The method comprises receiving, in the computing system, a notification of an event comprising information regarding the event and a process running in the data processing system that generated the event. The method further comprises determining, by the computing system, if one or more key performance indicators (KPIs) have been defined for an element corresponding to the process, in a model of the data processing system. Moreover, the method comprises, in response to one or more KPIs not having been defined for an element in the model corresponding to the process, automatically generating new KPI definitions for the element in the model corresponding to the process based on default KPIs specified in the computing system, wherein the new KPI definitions constitute an extension of the model of the data processing system to thereby generate an extended model of the data processing system. Furthermore, the method comprises monitoring an operation of the data processing system based on the extended model of the data processing system.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example representation of a distributed data processing system in which aspects of the illustrative embodiments may be implemented;

FIG. 2 is a block diagram of an example data processing system is shown in which aspects of the illustrative embodiments may be implemented;

FIG. 3 is an example block diagram of the primary operational components of a business monitoring system in accordance with one illustrative embodiment; and

FIG. 4 is a diagram outlining an example operation for extending a business system model in accordance with one illustrative embodiment.

### DETAILED DESCRIPTION

Owners, system administrators, and users of business computing systems want to be able to quickly and easily ascertain the state of their businesses and business systems without having to wait for their information technology departments to develop, test, and deploy business monitoring applications that will provide the information that they desire. That is, these individuals want to be able to see the values for Key Performance Indicators (KPIs), such as average time for loan approval, total sales revenue per month, number of loans processed per day, and the like, with a minimum amount of time and expense required to obtain such information. Moreover, such users want to be able to see whether such KPIs are within acceptable ranges and be alerted if they are outside these acceptable ranges. Furthermore, users want to be able to see the historical values of such KPIs and predict future values so that they can make decisions on how to improve their business processes in order to obtain better business results.

Various business monitoring systems are available that may be used by business users, systems administrators, or the like, to see such KPI information. However, in order to see the KPI information that is important to a particular business or organization, these business monitoring systems must be customized by having information technology department personnel invest time to author a custom monitoring model, test the custom monitoring model for both functional correctness (getting the correct values for the desired KPIs) and non-functional qualities of service (performance, availability, failover, error handling, etc.), deploy the customized business monitoring system, and then maintain the customized business monitoring system. It would be beneficial to be able to obtain this insight into performance of their business without having to incur the time and expense of having to use human resources to customize the business monitoring application.

Rather than having to create customized monitoring models for each of the business processes, an alternative approach is to create a globally applicable business process monitoring model that can listen to and gather generic monitoring data about any process running in a given system or application. Such a global model could track information that is common to all processes of the system or application, such as counts of instances, process and activity duration, and process variables. The drawback to such an approach is that it is often too generic. That is, while it can track data that aggregates across all kinds of processes, it does not let one track information that is really unique to a given process (such as the average duration of just the Loan Approval process, or the percentage of applicants with a credit score above 700). What is needed is a mechanism for utilizing a generic monitoring model but with the ability to customize the monitoring model so that business users, system administrators, or the like, can see important business measures at the necessary level of detail without the need for timely and costly involvement of information technology professionals in order to gain visibility to the customized data.

The illustrative embodiments provide a mechanism for providing a self-extending monitoring model that learns based on the arrival of new data. With the mechanisms of the illustrative embodiments, a generic monitoring model is able to extend its own definition based on arrival of events describing new processes for which the generic monitoring model is not yet customized or for which a change in customization is desired. For example, the first time a generic monitoring model sees an event that arrives where the pro cessTemplateName=LoanApproval (using Business Process Execution Language (BPEL) terminology), the generic monitoring model may automatically, in response to the event, extend the generic monitoring model's definition of KPIs specific to the Loan Approval process. Likewise, when the generic monitoring model sees a first event arrive for a given variable in that process, such as one containing a credit score or the like, the generic monitoring model may define a KPI specific to that variable. This may be done either automatically through an analysis of the event or through a semi-automatic or even manual process whereby a user may be involved and assist in the defining of a new KPI for a newly discovered variable in an event.

Thus, with the extendable generic monitoring model, the generic monitoring model may originally not have any knowledge of a particular process that is to be monitored but may learn of the existence of the process and generate KPIs for the process based on learned events that arrive from the process. In this way, the generic monitoring model may update itself dynamically to make such KPIs available to users, system administrators, and the like, without having to have information technology professionals expend human resources, time and cost to customize the generic monitoring model for every possible process to be monitored for a particular business system, application, or the like.

Once the business user has such KPIs available (that were generated automatically without any effort on the business user's part or on the part of the information technology personnel), the business user may then define alerts based on values of such KPIs. For example, a manager of loan officers may want to be alerted about risk being too high, such as if the average credit score for approved loans drops below 650. Having a dynamically learning monitoring model such as that provided by the mechanisms of the illustrative embodiments, increases the return on investment that a user gets from their business process management (BPM) solution.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations andlor block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart andlor block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

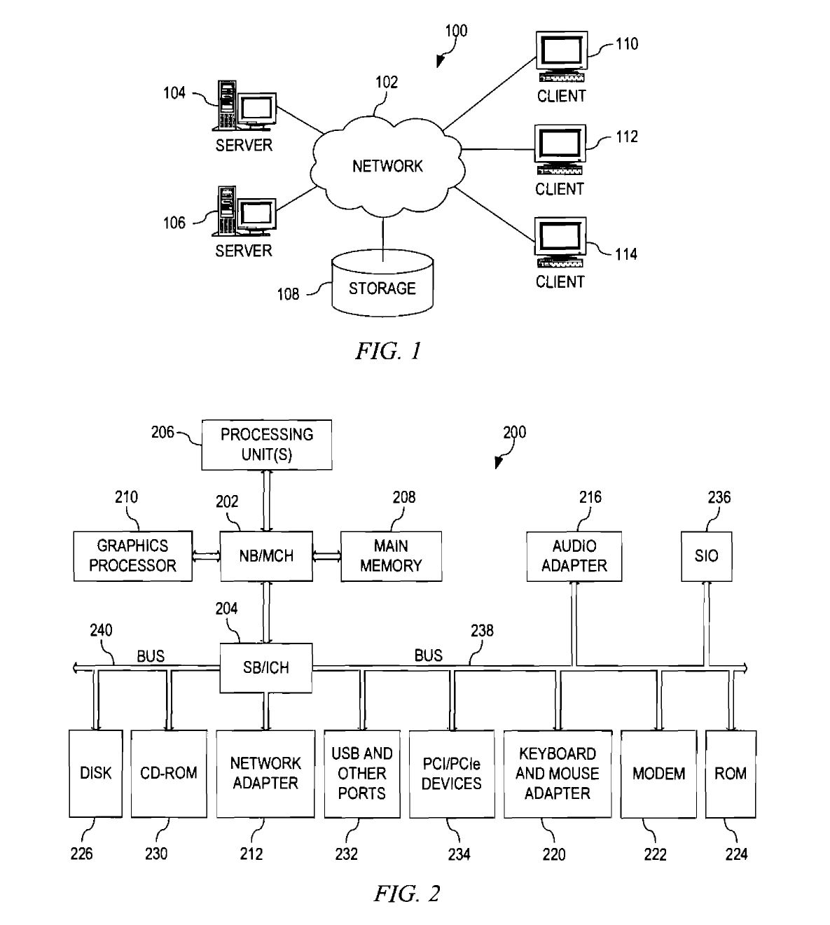

Since the mechanisms of the illustrative embodiments are directed to a dynamically extendable monitoring model system, it is evident that the illustrative embodiments are implemented in a data processing system for monitoring one or more business systems, applications, processes, or the like. As such, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SB/ICH 204 through bus 238 and bus 240. PCUPCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the L1NUX® operating system (eServer, System p, and AIX are trademarks of international Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

With the mechanisms of the illustrative embodiments, a computing device, such as server 104 or 106 may host or otherwise execute one or more business applications, processes, or the like, to thereby provide a business system. Moreover, the business system may involve many different computing devices coupled by one or more networks, e.g., system 100 in FIG. 1 may as a whole represent the business system with applications, processes, or the like, being executed on various ones of the computing devices shown which together may operate to provide a business system. For ease of explanation herein, however, it will be assumed that the business system is comprised of a single server computing device, such as server 104 or 106, running one or more applications or processes that are to be monitored by a business monitoring system utilizing an extendable generic model in accordance with one illustrative embodiment.

Either the same server computing device 104, 106, or a different server computing device may provide a business monitoring system that implements the mechanisms of one or more of the illustrative embodiments as described herein. The business monitoring system is provided with a generic model for monitoring the business system, i.e. the applications and processes executing on one or more computing devices that together define the business system. The generic model provides a general framework for monitoring the business system but does not provide a model for detailed monitoring of individual processes within the business system. For example, a generic model may be an XML model that a business analyst authors, tests, and debugs in an integrated development environment (IDE), not via a web browser, and information technology personnel deploys. The dynamically generated modifications to the generic model, as described hereafter, may be stored in a database and viewable by a user via a web browser without the user having to see and/or understand the full XML model or needing IT personnel to deploy the dynamic models.

The business monitoring system comprises a service that can be invoked for defining new key performance indicators (KPIs) for a given monitor model. Moreover, the business monitoring system comprises an engine for invoking this service in response to an event or upon the detection of a particular condition in the business system. These events/conditions may be user defined and/or may be pre-established within the business monitoring system. With the illustrative embodiments, events/conditions may be defined such that the KPI defining service is invoked when any new value of interest in events of interest are encountered during monitoring of the business system. The KPI defining service may make use of a configurable list of KPIs in a KPI list data structure that should be created whenever such a value of interest in an event of interest is encountered. For example, the KPI list may identify the KPIs that are created whenever a new kind of process is detected in the business system.

Thus, with the mechanisms of the illustrative embodiments, a business monitoring system, such as WebSphere Business Monitor, available from International Business Machines Corporation of Armonk, N.Y., may initially be configured to use a generic model of the business system that is to be monitored. This generic model may represent a very high level representation of the business system, for example, and may not have any details about specific applications, processes, or the like, that are utilized by the business system. The business monitoring system may then utilize the mechanisms of the illustrative embodiments to extend this generic model by generating KPIs for newly discovered applications, processes, and the like, as events are detected by the business monitoring system. The information in the events themselves trigger the generation of these KPIs for the newly discovered applications, processes, etc. and provide the information for establishing these KPIs so that the newly discovered applications, processes, etc. can be monitored by the business monitoring system.

It should be noted that this process is performed automatically based upon the detection of events by the business monitoring system without the intervention of a human user. That is, it is not necessary to load the generic model into an authoring environment and manually update it to accommodate the newly discovered applications, processes, etc. Thus, with the mechanisms of the illustrative embodiments, the time and expense of having to manually update business monitoring system models to accommodate newly introduced applications, processes, or the like, is dramatically reduced. Moreover, the amount of time required between introduction of a new application, process, or the like, and the ability to monitor that application, process, or the like with regard to KPIs is also dramatically reduced.

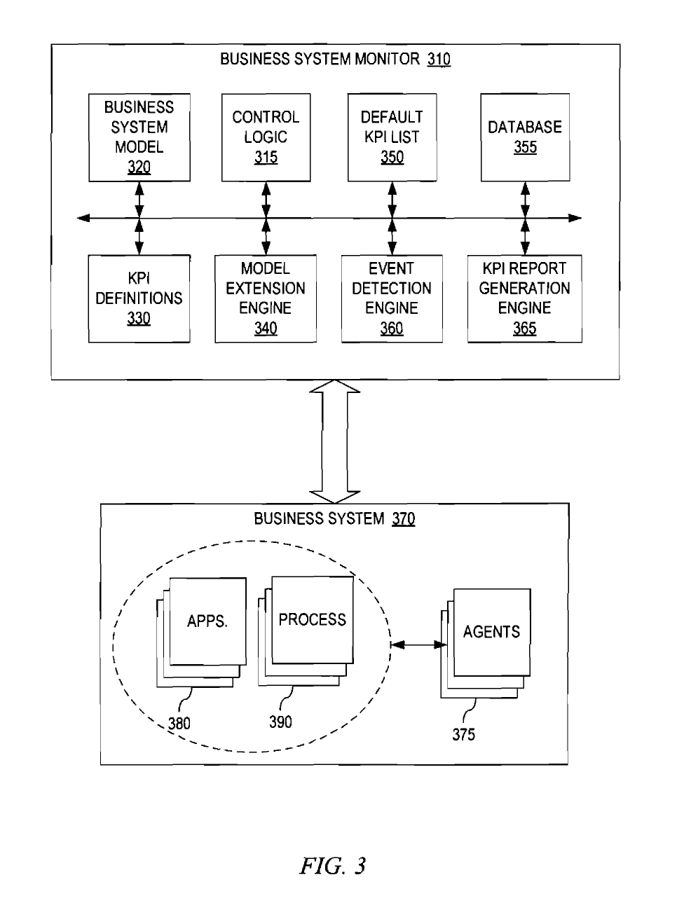

FIG. 3 is an example block diagram of the primary operational components of a business monitoring system in accordance with one illustrative embodiment. The elements shown in FIG. 3 may be implemented in software or a combination of software and hardware. In one illustrative embodiment, the elements shown in FIG. 3 are implemented as software instructions executing on one or more data processing devices or systems.

Moreover, it should be appreciated that while the illustrative embodiments are described herein as being applied to business system monitoring and business system models, the illustrative embodiments are not limited to such. Rather, the illustrative embodiments may be applied to any monitored system where a model of the system may be extended dynamically by detecting events/conditions within the monitored system and extending the model of the system based on the detected events/conditions. The various types of systems with which the illustrative embodiments may be used will become apparent to those of ordinary skill in the art in view of the present description.

As shown in FIG. 3, a business system monitor 310 may be used to monitor the operation of a business system 370 and provide key performance indicator (KPI) measurement reports, via a KPI report engine 365, for use by a user in determining the performance of the business system 370. The monitoring of the business system 370 by the business system monitor 310 may involve monitoring various applications 380, processes 390, and the like, executing on one or more data processing or computing devices/systems (not shown) that together make up the business system 370. Various agent applications 375 may be executing on these data processing or computing devices/systems for gathering information about the operation of the applications 380 and processes 390, as well as events occurring during the operation of the applications 380 and processes 390, so that this information may be communicated back to the business system monitor 310. In other illustrative embodiments, agent applications 375 may not be necessary and instead, the applications, processes, or the like, may report such events directly to the business system monitor 310 without having to implement agent applications 375. Such events may be reported in different types of formats. In one illustrative embodiment, the events may be sent to the business system monitor 310 as Extensible Markup Language (XML) formatted files/documents, other types of markup language based files/documents, or other type of format recognizable by the business system monitor 310.

The business system monitor 310 includes monitor control logic 315 which controls the overall operation of the business system monitor 310 and orchestrates the operation of the other elements of the business system monitor 310. The monitoring performed by the business system monitor 310 is performed based on a business system model 320 that models the applications 380, processes 390, data processing or computing devices/systems, and other elements of the business system 370. Initially, the business system model 320 may be a generic model that represents the business system 370 at a very high level and does not have details regarding each application 380 or process 390 executing within the business system 370 or even each data processing or computing device/system within the business system 370.

The business system monitor 310 may generate measures of KPIs according to the configuration of the business system model 320. That is, a user may generate KPI definitions 330 for specifying the KPIs of interest for various applications 380, processes 390, or the like. The KPIs for one application or process may be different from other KPIs for other applications or processes. The KPIs may be defined as a collection or properties, attributes, and/or elements, as is generally known in the art. A user may specify these KPIs via a user interface or the like.

The KPIs are used by the logic of the business system monitor 310, along with the business system model 320, to monitor the operation of the business system 370. For example, information about the operation of the applications 380, processes 390, and the like may be collected by the agents 375 and provided to the business system monitor 310 in the form of events that are detected by the event detection engine 360. The information in these events may be analyzed by the business system monitor 310 to update KPI information in a database 355 according to the defined KPIs 330 for the particular applications 380, processes 390, etc.

In addition, in accordance with the mechanisms of the illustrative embodiments, a user may define a default KPI list 350 for use in automatically extending the business system model 320 and the defined KPI list 330 when new events from previously unrecognized elements of the business system 370 are detected by the event detection engine 360. That is, when an event is received by the event detection engine 360 from an agent 375, the business system monitor 310 determines if the source, i.e. an application, process, or the like, of the event is unknown in the business system model 320, or if no KPIs have been defined in the KPI definitions 330 for the identified source of the event.

If the source of the event is not recognized in the model 320 or no KPIs have been defined for the source, then the model extension engine 340 is invoked to extend the existing business system model 320 based on the new event. The model extension engine 340 comprises logic for defining new elements in the business system model 320 corresponding to the identified source in the new event based on information in the new event. The model extension engine 340 further comprises logic for extending the KPI definitions 330 by applying the default KPIs in the default KPI list 350 to the newly identified source of the new event. That is, KPI definitions corresponding to the default KPIs 350 are automatically generated by the model extension engine 340, are associated with the new element of the business system model 320 generated by the model extension engine 340, and are stored in the KPI definitions 330. Thereafter, when additional events are received from this same source, the source will be identified as already present in the business system model 320 and the corresponding KPI definitions 330 will be used to extract appropriate KPI information from the event notifications and store the information in the database 355.

The application of the default KPIs from the default KPI list 350 may be performed automatically, as mentioned above, or semi-automatically with user input to assist in customizing the application of KPIs to newly discovered elements of the business system 370 based on events received by the event detection system 360. In a semi-automatic embodiment, in response to the event detection engine 360 detecting an event that is determined to be associated with a previously unknown element of the business system 370, the default KPI list 350 may be used to generate a graphical user interface through which a user may select KPIs of interest to be applied to the newly discovered element of the business system 370, override application of default KPIs, change attributes or the like of the KPIs, or the like. Moreover, an interface may be provided through which a user may select to edit their own KPIs to be applied to the newly discovered element of the business system 370. This may be used in addition to the automatic application of certain default KPIs such that unless a user specifically overrides the application of a default KPI, the default KPI is applied to the newly discovered element of the business system 370.

The business system monitor 310 further comprises a KPI report generation engine 365. Either periodically, or in response to an event, such as a user request or the like, the KPI report generation engine 365 may access the database 355 and generate a report based on KPI information stored in the database 355. The user request, or periodic automatic request, may specify which KPIs for which a report is desired and which elements of the business system 370 for which the designated KPIs are desired. The KPI report generation engine 365 may then generate a corresponding report, having bar graphs, line graphs, or any other generally known reporting format, that provides an indication of the KPIs of interest to the user. In one illustrative embodiment, the KPI report generation engine 365 may provide a user interface through which the defined KPIs in the KPI definitions 330 may be used as a basis for providing a KPI listing from which a user may select the KPIs of interest for which a report is to be generated.

For example, assume a new application 380 or process 390 was deployed in the business system 370, such as a new Loan Approval application in the business system 370. An agent 375 in the business system 370 may monitor the applications 380 including the newly deployed Loan Approval application, and generate an event that includes an identifier of the Loan Approval application as well as information about a particular communication, operation, change in state, or the like, of the Loan Approval application. The event detection engine 360 may detect the event sent by the agent 375 to the business system monitor 310 and determine whether the event corresponds to a new or already known element of the business system model 320. The event detection engine 360 may further determine whether KPIs have been established for the element of the business system 370, even if the element corresponding to the event is not a new element but corresponds to an already present element in the business system model 320.

If it is an event from a new element, or KPIs for the element are not already defined, then the model extension engine 340 is used to extend the business system model 320 to include an element corresponding to the Loan Approval application, if necessary. In addition, the default KPIs 350 may be applied to the newly added element, or the already existing element, in the business system model 320 to generate new defined KPIs in the KPI definitions 330. For example, one of the default KPIs may be a “Average Duration” KPI, a “Average Credit Score” KPI, or the like. The “Average Duration” KPI may be applied to the Loan Approval application to generate KPI information for the average duration of a loan approval process. The “Average Credit Score” KPI can be applied to the Loan Approval application to generate KPI information for the average credit score of approved loans generated by the Loan Approval application.

This KPI information may be extracted from events generated by the Loan Approval application. For example, when the Loan Approval application generates a result of a loan approval process (either granting the loan or disapproving the loan), the generation of the result and completion of the process may result in a corresponding agent 375 generating an event with general information about the completion of the process. This event may specify, among other things, the start time and end time of the process, the credit score associated with the applicant, and the like. This information may be communicated in an event sent to the business system monitor 310 and the business system monitor 310 may extract the necessary KPI information based on the business system model 320 and KPI definitions 330, thereafter storing the extracted information in the database 355. Thereafter, if a user desires to find out the average duration of the loan approval process for a specified period of time, or the average credit score for applicants whose loans are approved, then this information may be retrieved from the database 355 by the KPI report generation engine 365 to generate a corresponding report.

It is important to note that nowhere in the above process for extending the existing model of the business system 370 is there any need to load the business system model 320 into an authoring environment to manually update it. Rather, the mechanism of the illustrative embodiments operate automatically, or semi-automatically, with no need to generate new code, install an updated version of its Enterprise Archive (EAR) file, etc. User intervention is minimized and may be completely eliminated if desired. Thus, with the illustrative embodiments, the long time period necessary to modifying a business system model, as well as the costs of personnel time and downtime of the business system monitor to allow such modifying of the business system model using manual methods as are used in known mechanisms, are avoided.

It should be noted that while the illustrative embodiments aim to reduce the necessity of human intervention in extending business system models, the illustrative embodiments allow for human intervention when desired. As an example, in some illustrative embodiments a human may intervene in the operation of the illustrative embodiments by customizing target values for some of the newly created KPIs. For example, the target for the average process duration may be normally set to 30 minutes but, for a process that a system administrator knows requires human approval, a more appropriate target value may be set to 4 hours, or the like. Thus, in some illustrative embodiments, the automatic or semi-automatic embodiments may provide a generation of new KPIs using established target values in the automated or semi-automated system and these target values may be overridden by human intervention when appropriate.

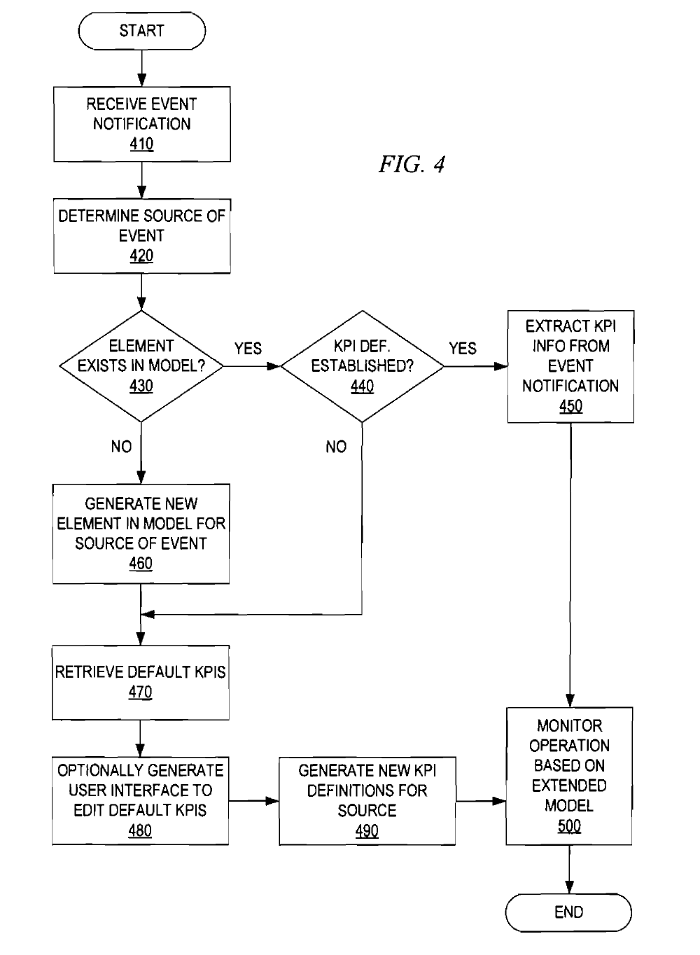

FIG. 4 is a diagram outlining an example operation for extending a business system model in accordance with one illustrative embodiment. As shown in FIG. 4, the operation starts with receiving an event notification from a monitored data processing system (step 410). A source of the event is determined based on the event notification (step 420) and a determination is made as to whether an element, corresponding to the source of the event, exists in a model of the data processing system (step 430). If so, a determination is made as to whether one or more KPI definitions have been established for the element corresponding to the source of the event (step 440). If one or more KPI definitions have been established for the element corresponding to the source of the event, then data corresponding to the KPI definitions are extracted from the event information provided in the event notification and used to update a database of data processing system performance information (step 450).

If no element exists in the model for the source of the event, then a new element is generated for the source of the event in the model (step 460). Thereafter, or if no KPI definitions have been established for an already existing element in the model corresponding to the source of the event, default KPIs are retrieved (step 470). Optionally, a user interface may be generated specifying these default KPIs so that a user may override the application of certain default KPIs or modify the attributes of the KPIs that are to be applied (step 480). The default KPIs, or modified default KPIs, are then applied to the element corresponding to the source of the event in the model to generate new KPI definitions for the new or previously existing element in the model corresponding to the source of the event (step 490). Thereafter, monitoring of the operation of the data processing system is performed based on the extended model having the new element and/or new KPI definitions (step 500). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards. displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing system, for monitoring a process of a data processing system, comprising:
receiving, in the computing system, a notification of an event comprising information regarding the event and a process running in the data processing system that generated the event;
determining, by the computing system, whether one or more key performance indicators (KPIs) have been defined for an element corresponding to the process, in a model of the data processing system;
in response to one or more KPIs not having been defined for an element in the model corresponding to the process, generating, by the computing system, new KPI definitions for the element in the model corresponding to the process based on default KPIs specified in the computing system, wherein the new KPI definitions constitute an extension of the model of the data processing system to thereby generate an extended model of the data processing system; and
monitoring an operation of the data processing system based on the extended model of the data processing system.

2. The method of claim 1, wherein the event is an event received from a process which is not already modeled in the model of the data processing system.

3. The method of claim 1, further comprising:
determining, by the computing system, whether the process is already modeled in the model of the data processing system; and
in response to the process not already being modeled in the model of the data processing system, generating, by the computing system, a new element, in the model of the data processing system, corresponding to the process, wherein the new element and new KPI definitions constitute the extension of the model of the data processing system, and wherein the new element is the element corresponding to the process.

4. The method of claim 1, wherein the model of the data processing system is a generic model of the general framework of the data processing system and does not provide a model for detailed monitoring of individual processes within the data processing system.

5. The method of claim 1, wherein the default KPIs are specified in a user defined KPI list data structure, and wherein the new KPI definitions are generated automatically using the KPI list data structure in response to detecting the event from the process.

6. The method of claim 5, wherein generating the new KPIs for the element in the model of the data processing system comprises:
retrieving a list of KPI definitions from the KPI list data structure;
presenting the list of KPI definitions to a user via a user interface;
receiving user input selecting one or more of the KPI definitions from the list of KPI definitions for creation of new KPI definitions for the element in the model of the data processing system; and
generating the new KPI definitions for the element in the model of the data processing system based on the user input.

7. The method of claim 1, wherein monitoring an operation of the data processing system based on the extended model comprises:
gathering operation information from additional events generated by the process executing in the data processing system based on the new KPI definitions in the extended model of the data processing system;
generating measures of KPIs corresponding to the new KPI definitions in the extended model of the data processing system based on the gathered operation information; and
storing the measures of KPIs in a data structure for generation of reports for users.

8. A computer program product comprising a computer readable storage medium having a computer readable program stored therein, wherein the computer readable program, when executed on a computing system, causes the computing system to:
receive a notification of an event comprising information regarding the event and a process running in the data processing system that generated the event;
determine whether one or more key performance indicators (KPIs) have been defined for an element corresponding to the process, in a model of a data processing system;
in response to one or more KPIs not having been defined for an element in the model corresponding to the process, generate new KPI definitions for the element in the model corresponding to the process based on default KPIs specified in the computing system, wherein the new KPI definitions constitute an extension of the model of the data processing system to thereby generate an extended model of the data processing system; and
monitor an operation of the data processing system based on the extended model of the data processing system.

9. The computer program product of claim 8, wherein the event is an event received from a process which is not already modeled in the model of the data processing system.

10. The computer program product of claim 8, wherein the computer readable program further causes the computing system to:
determine whether the process is already modeled in the model of the data processing system; and
in response to the process not already being modeled in the model of the data processing system, generate a new element, in the model of the data processing system, corresponding to the process, wherein the new element and new KPI definitions constitute the extension of the model of the data processing system, and wherein the new element is the element corresponding to the process.

11. The computer program product of claim 8, wherein the model of the data processing system is a generic model of the general framework of the data processing system and does not provide a model for detailed monitoring of individual processes within the data processing system.

12. The computer program product of claim 8, wherein the default KPIs are specified in a user defined KPI list data structure, and wherein the new KPI definitions are generated automatically using the KPI list data structure in response to detecting the event from the process.

13. The computer program product of claim 12, wherein the computer readable program further causes the computing system to generate the new KPIs for the element in the model of the data processing system by:
retrieving a list of KPI definitions from the KPI list data structure;
presenting the list of KPI definitions to a user via a user interface;
receiving user input selecting one or more of the KPI definitions from the list of KPI definitions for creation of new KPI definitions for the element in the model of the data processing system; and
generating the new KPI definitions for the element in the model of the data processing system based on the user input.

14. The computer program product of claim 8, wherein the computer readable program further causes the computing system to monitor an operation of the data processing system based on the extended model by:
gathering operation information from additional events generated by the process executing in the data processing system based on the new KPI definitions in the extended model of the data processing system;
generating measures of KPIs corresponding to the new KPI definitions in the extended model of the data processing system based on the gathered operation information; and
storing the measures of KPIs in a data structure for generation of reports for users.

15. An apparatus, comprising:
a processor; and
a memory coupled to the processor, wherein the memory comprises instructions which, when executed by the processor, cause the processor to:
receive a notification of an event comprising information regarding the event and a process running in the data processing system that generated the event;
determine whether one or more key performance indicators (KPIs) have been defined for an element corresponding to the process, in a model of a data processing system;
in response to one or more KPIs not having been defined for an element in the model corresponding to the process, generate new KPI definitions for the element in the model corresponding to the process based on default KPIs specified in the computing system, wherein the new KPI definitions constitute an extension of the model of the data processing system to thereby generate an extended model of the data processing system; and
monitor an operation of the data processing system based on the extended model of the data processing system.

16. The apparatus of claim 15, wherein the event is an event received from a process which is not already modeled in the model of the data processing system.

17. The apparatus of claim 15, wherein the instructions further cause the processor to:
determine whether the process is already modeled in the model of the data processing system; and
in response to the process not already being modeled in the model of the data processing system, generate a new element, in the model of the data processing system, corresponding to the process, wherein the new element and new KPI definitions constitute the extension of the model of the data processing system, and wherein the new element is the element corresponding to the process.

18. The apparatus of claim 15, wherein the model of the data processing system is a generic model of the general framework of the data processing system and does not provide a model for detailed monitoring of individual processes within the data processing system.

19. The apparatus of claim 15, wherein the default KPIs are specified in a user defined KPI list data structure, and wherein the new KPI definitions are generated automatically using the KPI list data structure in response to detecting the event from the process.

20. The apparatus of claim 19, wherein the instructions further cause the processor to generate the new KPIs for the element in the model of the data processing system by:
retrieving a list of KPI definitions from the KPI list data structure;
presenting the list of KPI definitions to a user via a user interface;
receiving user input selecting one or more of the KPI definitions from the list of KPI definitions for creation of new KPI definitions for the element in the model of the data processing system; and
generating the new KPI definitions for the element in the model of the data processing system based on the user input.

21. The apparatus of claim 15, wherein the instructions further cause the processor to monitor an operation of the data processing system based on the extended model by:
gathering operation information from additional events generated by the process executing in the data processing system based on the new KPI definitions in the extended model of the data processing system;
generating measures of KPIs corresponding to the new KPI definitions in the extended model of the data processing system based on the gathered operation information; and
storing the measures of KPIs in a data structure for generation of reports for users.
